(19) United States
(12) Patent Application Publication
(10) Pub. No.: US 2020/0307589 A1
(43) Pub. Date: Oct. 1, 2020

(54) AUTOMATIC LANE MERGE WITH TUNABLE MERGE BEHAVIORS

(71) Applicant: SF Motors, Inc., Santa Clara, CA (US)

(72) Inventors: Yiqian Li, Santa Clara, CA (US); Fan Wang, Santa Clara, CA (US)

(73) Assignees: Chongqing Jinkang New Energy Vehicle, Ltd., Chongqing (CN); SF Motors, Inc., Santa Clara, CA (US)

(21) Appl. No.: 16/368,874

(22) Filed: Mar. 29, 2019

(51) Int. Cl. B60W 30/18; B60W 30/16; G08G 1/16

(52) U.S. Cl. CPC B60W 30/18163; G08G 1/167; B60W 30/16

(57) ABSTRACT

An autonomous vehicle automatically implements a lane change in dense traffic condition. A minimum distance gap between the vehicle and a vehicle in front of the present vehicle is calculated for an autonomous vehicle, along with a best trajectory for changing lanes into a left adjacent lane or changing lanes into a right adjacent lane. The left or right lane change is triggered by the driver or the global planner that navigates the vehicle. During the next cycle, pre-calculated information is utilized by a planning module to determine the final speed of the trajectory to complete the final planning trajectory for the lane change.

### BACKGROUND

Some autonomous vehicles include technology that allows them to make a lane change when there are no vehicles in a neighboring lane. This is acceptable in limited conditions, but is not feasible when there are other vehicles in the neighboring lane. Further, these prior art technologies are not applicable to situations where a current lane ends or merges with another lane. It is important that autonomous vehicles operate in safe manner at all times.

### SUMMARY

The present technology, roughly described, is an autonomous vehicle (AV) system that navigates the AV to successfully and safely perform a merge from a current lane to a target lane. The process of performing a merge includes identifying road data for a current lane and a target lane, identifying the merge point, and identifying vehicle objects from captured perception data. For vehicle objects, the AV system can determine the current location, velocity, and acceleration of vehicle objects. A data processing system may predict the locations and velocity of the surrounding vehicle objects at different time points in the future, and generate sampled trajectories that target gaps expected to exist between the locations of the vehicles at the future times.

A candidate sampled trajectories is selected based at least in part on the cost of each trajectory. The cost may be based at least in part on jerk, longitudinal and latitudinal acceleration, safety, and an acceleration reward. The acceleration reward is generated from the positive or negative acceleration experienced by a merging vehicle due to the merge, as well as acceleration for the lagging vehicle and leading vehicle in the target lane, and in some cases a leading vehicle and/or lagging vehicle in the merging vehicles current lane, due to the merge of the AV. The acceleration reward determination may be weighted or tuned in order to emphasize an altruistic approach to merging or a selfish approach to merging. In the altruistic approach, the reward is increased when a change in acceleration required by other vehicles is low. In a selfish approach, the change in acceleration required other vehicles is not taken into account.

In embodiments, a system for automatically merging a vehicle from a current lane into a target lane includes a data processing system. The data processing system includes one or more processors, memory, a planning module, and a control module. The data processing system can detect a merge condition associated with a current lane from received sensor data and select a best trajectory from the current lane to the target lane. The best trajectory can be selected from a plurality of trajectories at least in part based on a determined cost of a lane change from the current lane, wherein the cost can be opposite value or additive inverse to a change in acceleration in one or more vehicles, and the one or more vehicles can include the automatically merging vehicle. For example, if the reward has a value of 0.5, the corresponding cost is −0.5. If the reward is −0.2, then the corresponding cost is 0.2. The data processing system can also generate one or more commands to navigate a merge from the current lane to the target lane.

In embodiments, a non-transitory computer readable storage medium includes a program, the program being executable by a processor to perform a method for automatically merging a vehicle from a current lane into a target lane includes a data processing system. The method includes detecting a merge condition associated with a current lane from received sensor data, and selecting a best trajectory from the current lane to the target lane. The best trajectory selected from a plurality of trajectories at least in part based on a determined cost of a lane change from the current lane, the cost being the opposite value of an acceleration reward that corresponds to a change in acceleration in one or more vehicles, and the one or more vehicles including the automatically merging vehicle. The method also includes generating one or more commands to navigate a merge from the current lane to the target lane.

In embodiments, a method is disclosed for automatically merging a vehicle from a current lane into a target lane includes a data processing system. The method includes detecting, by a data management system, a merge condition associated with a current lane from received sensor data. The data management system selects a best trajectory from the current lane to the target lane, the best trajectory selected from a plurality of trajectories at least in part based on a determined cost of a lane change from the current lane. The cost is the opposite value to the acceleration reward based on a change in acceleration in one or more vehicles, and the one or more vehicles include the automatically merging vehicle. The method also includes generating, by a data management system, one or more commands to navigate a merge from the current lane to the target lane.

### BRIEF DESCRIPTION OF FIGURES

FIG. 1A is an illustration of an autonomous vehicle approaching a merge point in a road.

FIG. 1B is an illustration of a virtual object created on a road at a merge point.

FIG. 1C is an illustration of candidate navigation paths for an autonomous vehicle on a road having a merge point.

FIG. 2 is a block diagram of an autonomous vehicle.

FIG. 3 is a block diagram of a data processing system.

FIG. 4 is a method for planning and executing a merge action by an autonomous vehicle.

FIG. 5 is a method for receiving and processing perception data to generate lane detection data and an object list.

FIG. 6 is a method for planning a merge action.

FIG. 7 is a method for generating a sampling of potential merge paths.

FIG. 8 is a method for determining a trajectory cost.

FIG. 9 is a block diagram of a computing environment for the present technology.

### DETAILED DESCRIPTION

The present technology, roughly described, is an autonomous vehicle (AV) system that navigates the AV to successfully and safely perform a merge from a current lane to a target lane. The process of performing a merge includes identifying road data for a current lane and a target lane, identifying the merge point, and identifying vehicle objects from captured perception data. For vehicle objects, the AV system can determine the current location, velocity, and acceleration of vehicle objects. A data processing system may predict the locations and velocity of the surrounding vehicle objects at different time points in the future, and generate sampled trajectories that target gaps expected to exist between the locations of the vehicles at the future times.

A candidate sampled trajectory is selected based at least in part on the cost of each trajectory. The cost may be based at least in part on jerk, longitudinal and latitudinal acceleration, safety, and an acceleration reward. The acceleration reward is generated from the positive or negative acceleration experienced by a merging vehicle due to the merge, as well as acceleration for the lagging vehicle and leading vehicle in the target lane, and in some cases a leading vehicle and/or lagging vehicle in the merging vehicles current lane, due to the merge of the AV. The acceleration reward determination may be weighted or tuned in order to emphasize an altruistic approach to merging or a selfish approach to merging. In the altruistic approach, the reward is increased when a change in acceleration required by other vehicles is low. In a selfish approach, the change in acceleration required other vehicles is not taken into account.

The AV system can navigate different types of merging scenarios, including but not limited to highway on-ramps, merging on to major roads, and other merge scenarios. In some instances, when a merge does not include an exit to get off the current lane, a virtual object may be created at a point where the current lane ends. The virtual object may be used by an adaptive cruise control (ACC) system to track the remaining distance until the AV reaches the virtual object. As the AV gets near the virtual object, audio, video, graphical, and other alerts may be provided to the user of the AV that a merge must be completed soon. In some instances, the AV may turn control of the AV to the user and/or stop the AV if the AV gets within a threshold distance of the virtual object.

The technical problem addressed by the present technology involves safely and successfully merging from a current lane to a target lane in different road scenarios. Typical automated lane change systems require a significant amount of empty space in the current lane and the adjacent lane before the lane change may be considered. In many merge situations, the required amount of empty space is simply not available, and the typical “lane change” technology utilizing a large gap between vehicles does not work. As a result, prior lane change systems are unable to accomplish safe and effect merging in a variety of merge scenarios. This issue in autonomous computer-controlled vehicles results in an inefficient navigation and, often times, a failure to navigate to a desired point.

The present technology provides a technical solution to the technical problem of safely and effectively implementing a merge to a target lane to which the AV intends to navigate. The solution is to plan for a large enough gap and selecting the best trajectory into the target lane. For situations wherein the current lane eventually ends without any exit, a virtual object is created at the end of the lane so that the AV can implement safety steps to prevent the AV from proceeding along detected lane lines blindly into a merging lane or collide with a road boundary.

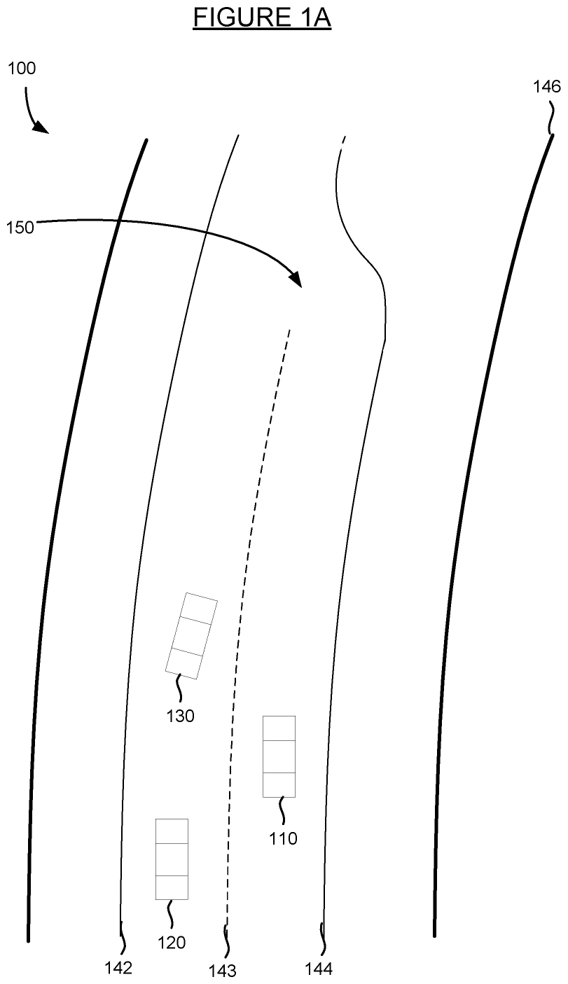

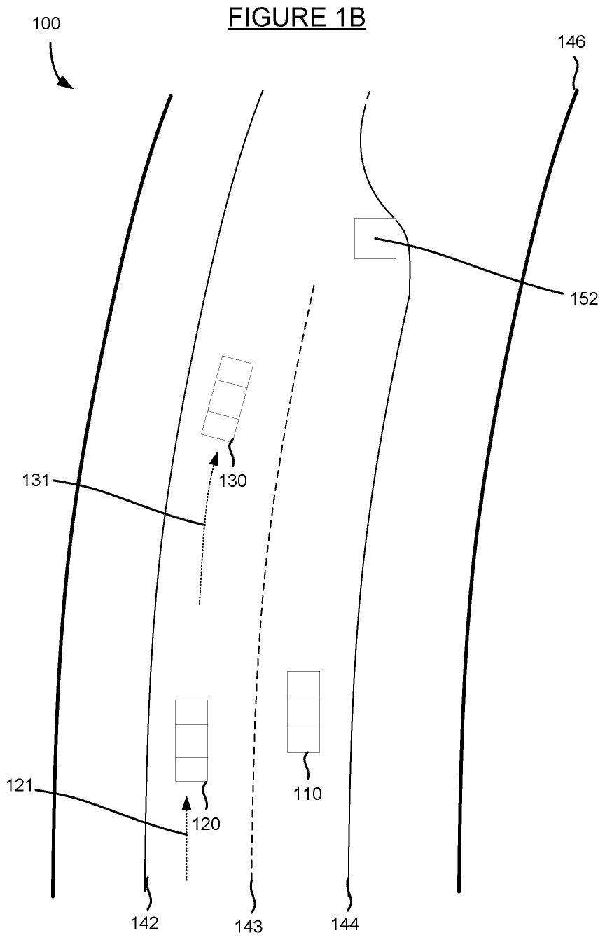

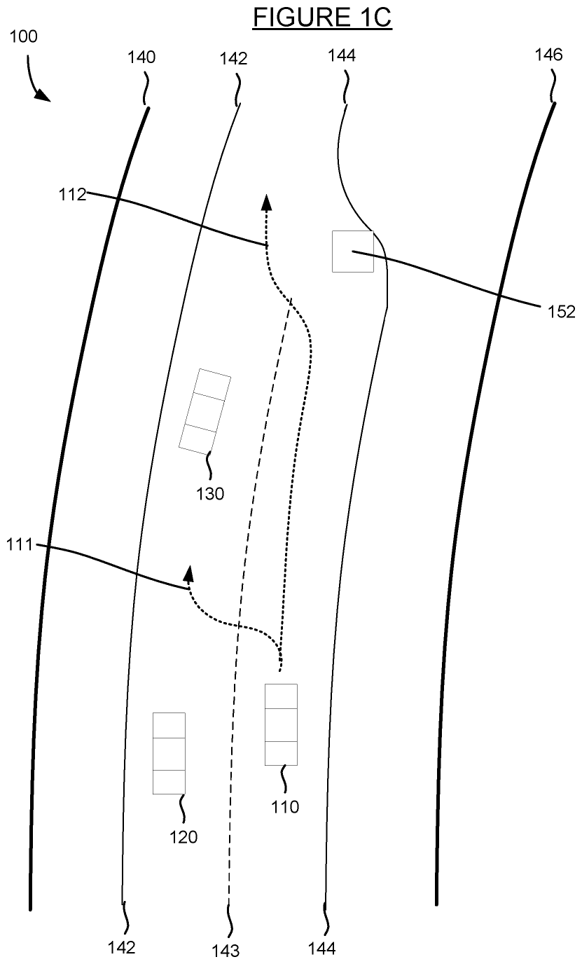

FIG. 1A is an illustration of an autonomous vehicle approaching a merge point in a road. FIG. 1A includes a road 100 having boundaries 140 and 146. Within the road boundaries, the road includes outer lane lines 142 and 144, separated by a dashed lane line 143. The two lanes formed by lane lines 142-143 merge at point 150, in which the right lane merges into the left lane. As shown, the merge can be detected by camera image data that illustrates lane line 144 converging towards lane line 140, and dotted lane line 143 ending near point 150. The merge point may also be detected by map data that is accessible by a data processing system of an AV.

Traveling on the road 100 are vehicles 110, 120, and 130. Vehicle 110 represents an AV that should merge from the right lane (current lane) formed by lane lines 143 and 144 into the left lane (target lane) formed by lane lines 142 and 143. Vehicle 120 is a lagging vehicle in the target lane, in that the front of vehicle 120 is behind the front of vehicle 120, and vehicle 130 is a leading vehicle in the target lane, with the front of vehicle 130 in front of vehicle 110.

Autonomous vehicle 110 may capture and process perception data to identify the location, velocity, and acceleration of other vehicles in the current lane and target lane. Vehicles 120 and 130 can be detected as vehicle objects by cameras and sensors on AV 110, each with a detected location, velocity and acceleration. From the positions illustrated in FIG. 1A to subsequent positions in FIG. 1B, during which a period of time transpires and processing cycles occur, perception data is captured and processed. From the captured and processed perception data, AV 110 can predict that lagging vehicle 120 may travel forward a distance 121 during a future time interval while leading vehicle 130 may travel forward a distance 131 during the future time interval. Based on the perception data processed over several processing cycles, AV 110 can determine that leading vehicle 130 is accelerating at a faster rate than vehicle 120. As such, AV 110 can predict that a gap is created between vehicles 120 and 130.

FIG. 1B is an illustration of a virtual object created on a road at a merge point. In merging scenarios, a current lane from which an AV initiates a merge may or may not include an exit at the end of the current lane. If there is an exit at the end of the current lane, then if the merge is not executed, the AV may take the exit and navigate back onto the road to continue its original navigation plan. If a merge is not associated with an exit or offramp in the current lane, then a virtual object 152 may be created at the end of the current lane. The virtual object is created to establish a point at which the AV will not proceed in the current lane. An adaptive cruise control (ACC) system may detect the virtual object, and may control the AV to slow down and even stop if a merge is not successfully completed by the time the autonomous vehicle is directly in front of the virtual object 152.

FIG. 1C is an illustration of candidate navigation paths for an autonomous vehicle on a road having a merge point. After capturing and processing perception data which identifies geometric road data as well as vehicle objects traveling on the road, an AV data processing system may generate potential trajectories to be executed at points in time based on the predicted vehicle object location and gaps formed between those vehicles in the target lane. For example, autonomous vehicle 110 may generate a trajectory candidate 111 to navigate between leading vehicle 130 and lagging vehicle 120 as well as candidate trajectory 112 to navigate in front of leading vehicle 130. Trajectory 112 could require more acceleration for autonomous vehicle 110 as opposed to the amount of acceleration to navigate along trajectory 111. This would be taken into consideration as part of the cost of each trajectory, from which a best trajectory with the lowest cost would be selected. As shown, each trajectory navigates the autonomous vehicle 110 into the target lane before the merge point of the current lane, and before virtual object 152.

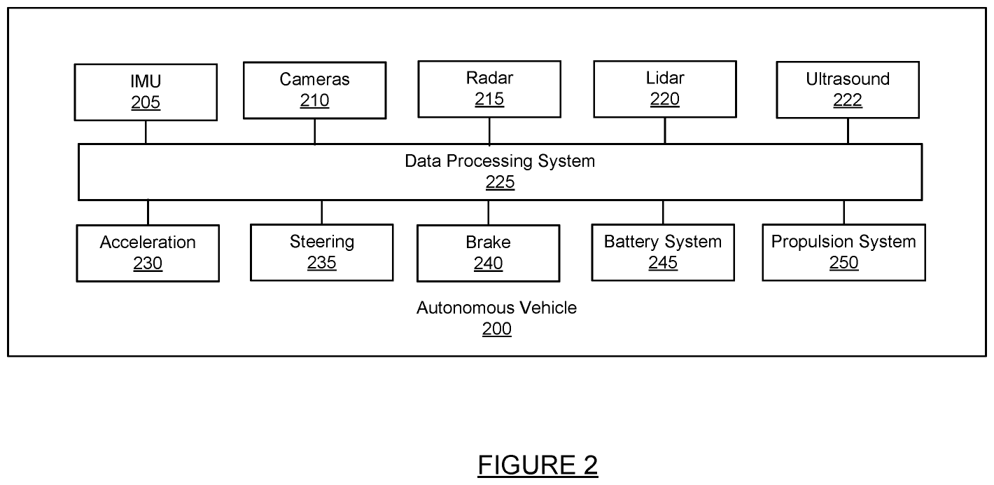

FIG. 1 is a block diagram of an AV. The AV 210 of FIG. 2 includes a data processing system 225 in communication with an inertia measurement unit (IMU) 105, cameras 210, radar 215, lidar 220, and ultrasound sensor 222. Data processing system 225 may also communicate with acceleration 230, steering 235, brake 240, battery system 245, and propulsion system 250. The data processing system and the components to communicate with are intended to be exemplary for purposes of discussion. It is not intended to be limiting, and additional elements of an AV may be implemented in a system of the present technology, as will be understood by those of ordinary skill in the art.

IMU 205 may track and measure the AV acceleration, yaw rate, and other measurements and provide that data to data processing system 225.

Cameras 210, radar 215, lidar 220, and ultrasound 222 may form all or part of a perception component of AV 210. The AV may include one or more cameras 210 to capture visual data inside and outside of the AV. On the outside of the AV, multiple cameras may be implemented. For example, cameras on the outside of the vehicle may capture a forward-facing view, a rear facing view, and optionally other views. Images from the cameras may be processed to detect objects such as streetlights, stop signs, lines or borders of one or more lanes of a road, vehicles, and other aspects of the environment. To detect the objects, pixels of images are processed to recognize objects in singular images and series of images. The processing may be performed by image and video detection algorithms, machine learning models which are trained to detect particular objects of interest, neural networks, and other techniques.

Radar 215 may include multiple radar sensing systems and devices to detect objects around the AV. In some instances, a radar system may be implemented at one or more of each of the four corners of the vehicle, a front of the vehicle, a rear of the vehicle, and on the left side and right side of the vehicle. The radar elements may be used to detect stationary and moving objects in adjacent lanes as well as in the current lane in front of and behind the AV. Lidar may also be used to detect objects in adjacent lanes, as well as in front of and behind the current vehicle.

Ultrasound 222 may include one or more ultrasound sensors that detect the presence of objects in the vicinity of the AV. The ultrasound sensors can be positioned at one or more locations around the perimeter of the car to detect stationary and moving objects.

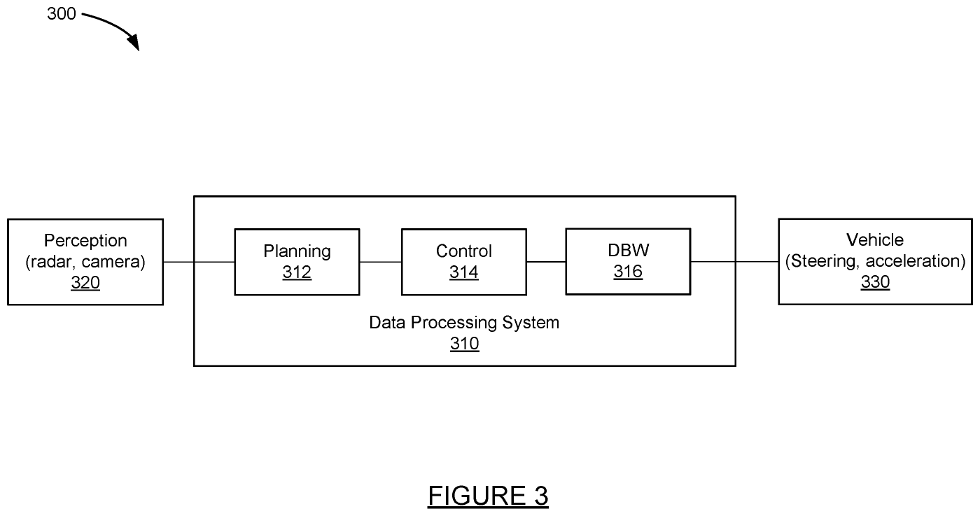

Data processing system 225 may include one or more processors, memory, and instructions stored in memory and executable by the one or more processors to perform the functionality described herein. In some instances, the data processing system may include a planning module, a control module, and a drive-by wire module. The modules communicate with each other to receive data from a perception component plan actions such as lane changes, and generate commands to execute lane changes. The data processing system 225 is discussed in more detail below with respect to the system of FIG. 3.

Acceleration 230 may receive commands from the data processing system to accelerate the AV. Acceleration 230 may be implemented as one or more mechanisms to apply acceleration to the propulsion system 250. Steering module 235 controls the steering of the AV, and may receive commands to steer the AV from data processing system 235. Brake system 240 may handle braking applied to the wheels of AV 210, and may receive commands from data processing system 225.

Battery system 245 may include a battery, charging control, battery management system, and other modules and components related to a battery system on an AV. Propulsion system 250 may manage and control propulsion of the vehicle, and may include components of one or more combustion engines, electric motors, drivetrains, and other components of a propulsion system utilizing an electric motor with or without a combustion engine.

FIG. 3 is a block diagram of a data processing system within an AV. Data processing system 310 provides more detail for data processing system 225 of the system of FIG. 2. Data processing system may receive data and information from perception components 320. Perception component 220 may include camera, radar, lidar, and ultrasound elements, as well as logic for processing the output captured by each element to identify objects of interest, including but not limited to vehicle objects, lane lines, merge scenarios on a road, and other environment elements. Perception 320 may provide a list of objects, lane detection data, and other data to planning module 312.

Planning module 312 may receive and process data and information received from the perception component to plan actions for the AV. The actions may include navigating a merge from a current lane to a target lane, slowing down and/or stopping before an in-path virtual object, stopping, accelerating, turning, and performing other actions. Planning module 312 may generate samples of trajectories between two lines or points, analyze and select the best trajectory, and provide a best trajectory for navigating from one point to another to control module 314.

Control module 314 may receive information from the planning module, such as a selected trajectory over which a lane merge should be navigated. Control module 314 may generate commands to be executed in order to navigate the selected trajectory. The commands may include instructions for accelerating, braking, and turning to effectuate navigation along the best trajectory.

Drive-by wire module 316 may receive the commands from control module 316 and actuate the AV navigation components based on the commands. In particular, drive-by wire 316 may control the accelerator, steering wheel, brakes, and turn signals of the AV.

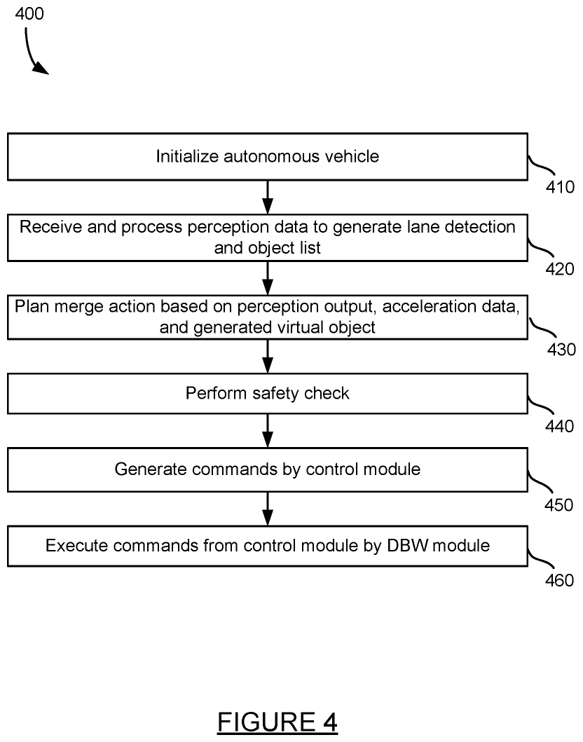

FIG. 4 is a method for planning and executing a merge action by an AV. In AVs initialized at step 410. Initializing the AV may include starting the AV, performing an initial system check, calibrating the vehicle to the current ambient temperature and weather, and calibrating any systems as needed at startup.

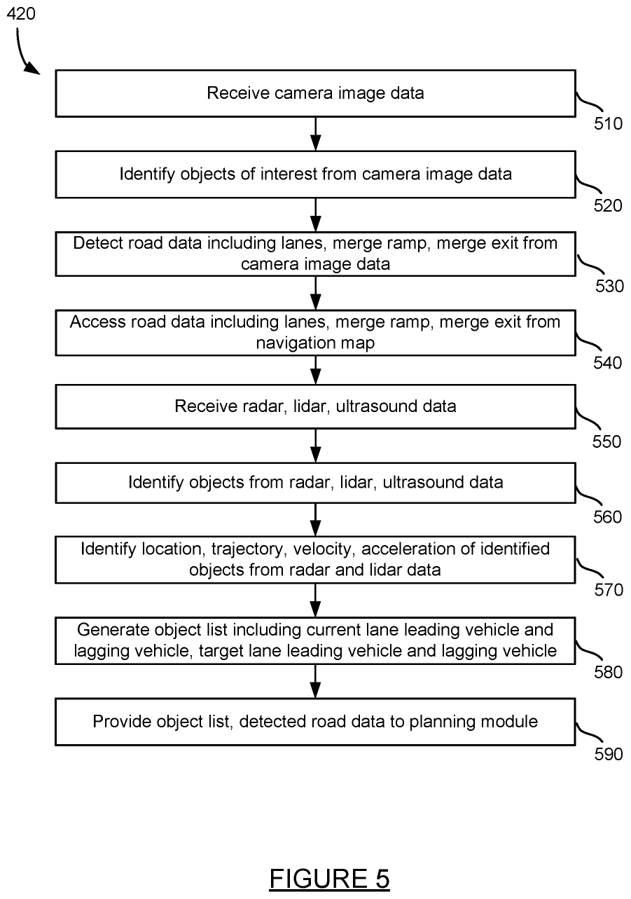

Perception data is received and processed to generate lane detection and an object list at step 420. The perception data may include camera image data, lane, merge ramp, merge exits, and other road data from camera image data, road data from a navigation map, and radar, lidar, and other sensor data. The data may be processed to provide road information and an object list by logic associated with the perception component. The road information and object list are then provided to a planning module of the data processing system. In some instances, receiving and processing perception data is performed on an ongoing basis, and timing of step 420 in the method of FIG. 4 is for purposes of discussion only. More details for receiving and processing perception data is discussed with respect to the method of FIG. 5.

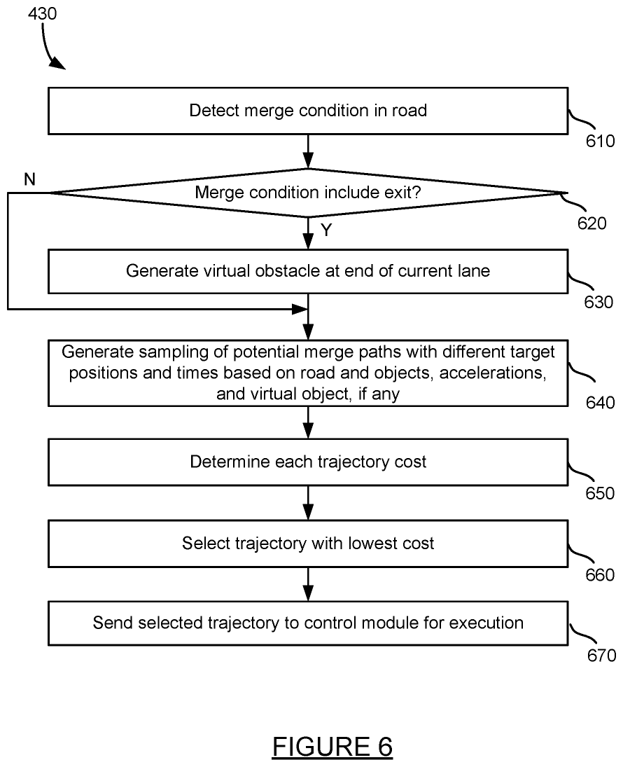

A merge action is planned based on perception output, acceleration data, and the generated virtual object if any at step 430. In some instances, a virtual object is generated when a current lane which merges into a target lane does not include an exit. Planning the action may include generating samples of potential merging paths, determining the cost of each trajectory, selecting a trajectory, and sending the selected trajectory to a control module for execution. More details for planning a merge action are discussed with respect to the method of FIG. 6. A safety check is performed at step 440. A safety check may include confirming all obstacles exist along the selected trajectory, no collisions will occur along the selected trajectory, and that the AV can physically navigate along the selected trajectory. The data processing system can confirm that the objects in the object list are not positioned in the trajectory as well as any new objects detected by radar, lidar, or camera data. Collisions may be detected to occur if an unexpected curvature in the road occurs, an unexpected boundary within a road is detected, or some other unforeseen obstacle appears in the selected trajectory.

Commands to navigate a merge are generated by a control module at step 450. The merge navigation commands can be used to control the AV steering, acceleration, braking, signaling, and other aspects of the AV to perform the selected merge action. For example, one or more commands may include turn 10° to the left while accelerating at 3 mph for 100 feet, and then turning this steering wheel back to dead center with no acceleration for 30 feet, and so forth. The commands are provided by the control module to the drive-by wire module. The generated commands are executed by the drive-by wire module at step 460. The drive-by wire module may control the AV brakes, acceleration, and steering wheel, based on the commands received from the control module. By executing the commands, the drive-by wire module makes the AV proceed along the selected trajectory to execute a merge.

FIG. 5 is a method for receiving and processing perception data to generate lane detection data and an object list. The method of FIG. 5 provides more detail for step 420 of the method of FIG. 4. First, camera image data is received at step 510. The camera image data may include images and/or video of the environment through which the AV is traveling. Objects of interest may be identified from the camera image and/or video data at step 520. Objects of interest may include a stop light, stop sign, other signs, vehicles, and other objects of interest that can be recognized and processed by the data processing system. In some instances, image data may be processed using pixel clustering algorithms to recognize certain objects. In some instances, pixel data may be processed by one or more machine learning models are trained to recognize objects within images, such as vehicles, traffic light objects, stop sign objects, other sign objects, road lane lines, and other objects of interest.

Road lanes are detected from the camera image data at step 530. Road lane detection may include identifying the boundaries of a particular road, path, or other throughway, merging lanes, merge ramps, and merge exits. The road boundaries and lane lines may be detected using pixel clustering algorithms to recognize certain objects, one or more machine learning models trained to recognize road boundary and lane objects within images, or by other object detection methods.

Road data including road lanes, merge lanes, merge ramps, merge exits, and other road data may be accessed from a navigation map at step 540. The navigation map may be accessed locally from memory or remotely via one or more wired or wireless networks.

Radar, lidar, and ultrasound data are received at step 550, and the received data may be processed to identify objects within the vicinity of the AV, such as between zero and several hundred feet of the AV at step 560. The processed radar, lidar, and ultrasound data may indicate the speed, trajectory, velocity, and location of an object within the range of sensors on the AV (step 570). Examples of objects detectable by radar, lidar, and ultrasound include cars, trucks, people, and animals.

An object list of the objects detected via radar, lidar, ultrasound, and objects of interest from the camera image data is generated at step 580. For each object in the list, information may be included such as an identifier for the object, a classification of the object, location, trajectory, velocity, acceleration of the object, and in some instances other data. The object list, road boundaries, lane merge data, and detected lanes is provided to a planning module at step 590.

FIG. 6 is a method for planning a merge action. The method of FIG. 6 provides more detail for step 430 of the method of FIG. 4. First, a merge condition is detected in a road being navigated by the AV at step 610. The merge condition can include a highway on-ramp merge, a merge onto a major road, a merge onto a major road after a stop sign, a merge onto a major road after a yield sign, and a merge into another lane because of a lane closure, natural or man-made obstacle, or other reason.

A determination is made as to whether a merge condition includes an exit at step 620. As part of detecting the merge condition, a determination may be made as to whether an exit exists at the end the current lane. The merge condition may or may not include an exit in the current lane that allows an AV to exit off the road rather than merge into a target lane. If a merge condition does not include an exit, the operation of method 430 continues to step 640. If the merge does include an exit, a virtual obstacle is generated at the end of the current lane at step 630.

The virtual object generated at the end of the current lane has the same properties as an object detected from perception data except that the object does not physically exist. For example, the virtual object can have a location, can be classified as a particular type of object, such as an automobile or unknown object, and has a velocity and acceleration of zero. The virtual object is recognized by the data processing system and will force the AV to stop before colliding with the object. As a result, the AV can take other actions before moving forward past the end of the current lane. In some instances, an adaptive cruise control implemented on the AV can control the AV to stop before it virtually collides with the virtual object. In some instances, when the AV gets close to the virtual object, the ACC may initiate an alert to the user and request the user take control of the vehicle. If the AV appears to not be able to merge before reaching the virtual object, and the user does not take control of the vehicle in response to the alert, the data processing system of the AV may stop the AV.

In some instances, the AV can approach the virtual obstacle positioned at the end of the merge lane. In this case, the AV can begin to apply its brakes, resulting in the acceleration of the AV becoming negative. As the AV continues to apply its brakes, its acceleration becomes even more negative. In this scenario, the acceleration reward for changing to the other lane becomes higher as the AV's acceleration itself becomes increasingly negative. The result is that the AV is more aggressive, more likely to squeeze into a gap between vehicles in the target lane, and the system may then tolerate other costs associated with the planned navigation which may increase, such as: increased jerk, or causing the lagging vehicle to apply more braking. In this scenario, the AV tries to avoid being too conservative or “polite” and stop completely before the end of the merge lane, which is not ideal for completing a lane change.

In some instances, the AV may not find an acceptable lane change trajectory and would eventually be stopped by the virtual obstacle. In this scenario, the system will choose a trajectory that has a higher acceleration of the AV onto the target lane, and confirm that there would be no collision. In some instances, a higher acceleration of the AV will have less of an impact in terms of acceleration for the approaching vehicle on the target lane. Therefore, the AV trades comfort of the trajectory in exchange for a higher acceleration reward.

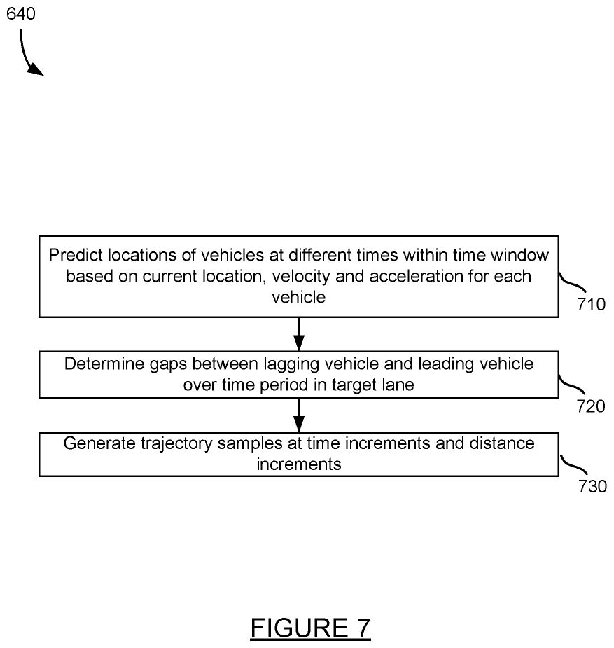

A sampling of potential merge paths is generated at step 640. Each sampled trajectory may be from the current lane to the target lane, and may involve navigation that places the AV in the target lane at the time of a gap between vehicles. In particular, the potential merge paths may have different target positions and different target completion times based on the detected road data and objects, accelerations of the present vehicle and other vehicles on the road, and a virtual object, if any. More detail for generating a sampling of potential merge path is discussed with respect to the method of FIG. 7.

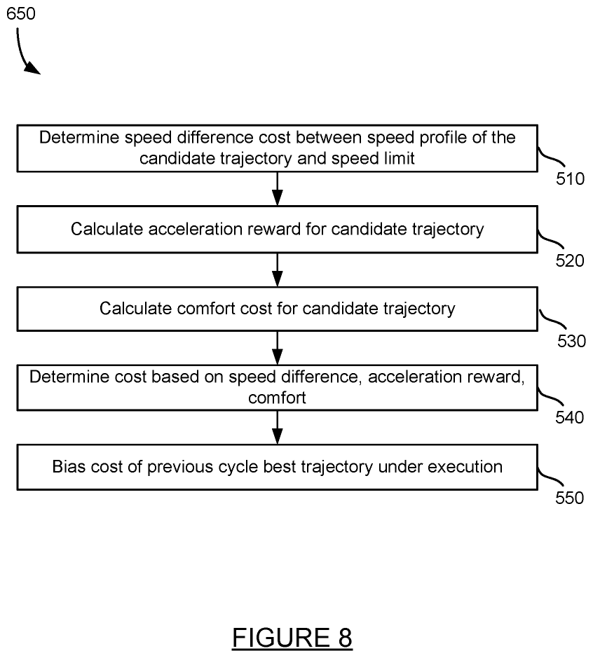

The trajectory cost is determined for each trajectory at step 650 the trajectory cost may be determined based on changes in speed, changes and acceleration, safety, and comfort data associated with navigating each trajectory. More details for determining a cost for each trajectory is discussed with respect to the method of FIG. 8.

The trajectory with the lowest cost is selected at step 660. The lowest cost trajectory can be selected by the planning module of the data processing system. The selected trajectory may then be sent to a control module for execution at step 670. The control module may then generate commands to execute the trajectory by the AV.

FIG. 7 is a method for generating a sampling of potential merge paths. The method of FIG. 7 provides more detail for step 640 of the method of FIG. 6. Locations of vehicles are predicted at different times at step 710. The vehicles may include an in-path (current lane) leading vehicle that is in front of the AV, a leading vehicle in the target lane, and a lagging vehicle in the target lane. The different times at which locations may be determined may be within a time window based on a current location, velocity, and acceleration for each vehicle. For each vehicle object, the perception data associated with each object includes a vehicle location, velocity, and acceleration. Assuming a constant acceleration, the location of each vehicle can be predicted at different intervals within a time window, such as for example every 0.2 seconds for a period of 10 seconds.

From the predicted locations, gaps between vehicles can be determined—such as for example between a lagging vehicle and leading vehicle in a target lane—at step 720. The gaps may be determined at different points in time between the vehicles in the target lane. By determining gaps that will be existing at different points of time, as well as at different locations for a target vehicle, the AV can identify target locations for which a trajectory can be generated to merge the AV into a suitable gap within the target lane. A suitable gap can include a space between a leading vehicle and lagging vehicle that will safely accommodate the AV as the AV enters that target lane. Trajectory samples are generated at time increments and distance increments at step 730. For each time and distance increment, the sampled trajectory includes a path from the AV at the particular time to a position in the target lane within gap between two vehicles or other available space within the target lane.

FIG. 8 is a method for determining a trajectory cost. The method of FIG. 8 provides more detail for step 650 of the method of FIG. 6 and is performed for each candidate trajectory being considered for the AV. In some instances, for each factor in the ranking of a trajectory, the ranking is increased or decreased based on the outcome of a determination. For example, if a determination suggests that a trajectory may not be comfortable, the comfort ranking may be cut in half or reduced by a certain percentage. In some instances, some determinations may have a higher weighting than others, such as for example objects detected to be in the particular trajectory.

A speed difference cost between a speed profile of a candidate trajectory and the current speed limit is determined at step 510. The cost of the speed is proportional to the difference in the AV target speed at the end of the trajectory and the speed limit for the road.

An acceleration reward is determined for each candidate trajectory at step 520. The acceleration reward may be affected by the present AV acceleration, acceleration required by the lagging vehicle in the target lane and the lagging vehicle in the ego (current) lane. For each vehicle, the acceleration change can be positive or negative. The acceleration reward can be represented as:

Reward=l1*a_diff_AV+l2*a_diff_target_lagging+l3*a_diff_ego_lagging−threshold, Eqn 1.

where a_diff means the predicted acceleration change, which is the predicted acceleration at planned target point minus the current acceleration, and l1, l2, l3 are weighting factors. The threshold can be biased to make the lane change aggressive. The l2, and l3 factors can be considered as a politeness factor, wherein the higher the values of l2 and l3, the “politer” the AV will act with respect to merging in front of other cars. For a less polite, selfish driving AV, the factor l2 and l3 can be set to 0. The cost of the acceleration can depend on the acceleration reward. In some instances, the cost of acceleration can be determined as the opposite value of the acceleration reward, wherein:

Acceleration Cost=−reward Eqn 2.

The reward and the acceleration cost are opposite values of each other. So, when the reward is positive, the cost is negative, and the trajectory's costs is preferable for lane change. When reward is negative, the cost is positive and added to the overall cost, which may discourage the lane change. When the reward is zero, the acceleration reward has no impact on the planner. The comfort cost (i.e., constraint considerations) of the current trajectory is evaluated at step 530. The constraints may include a lateral boundary, lateral offset, lateral speed, lateral acceleration, lateral jerk, and curvature of lane lines. Each constraint may increase or reduce the ranking of a particular trajectory based on the value of a constraint and thresholds associated with each particular constraint. For example, if a trajectory would result in a strong jerk in a lateral or longitudinal direction, the trajectory is determined to not be comfortable for a user and is assigned a high cost in comfort. In some instances, the cost and acceleration reward may be interdependent in other ways, such as for example if the cost was inversely proportional to the acceleration reward. The comfort cost can be based on default settings or user preferences.

The overall cost based on the speed difference, acceleration reward, and comfort costs is determined at step 540. In some instances, the overall cost can be an average of these costs, or a weighted sum of the different costs. The overall costs can be determined by default weightings (e.g., equal weighting) or different weighting determined by user preferences.

A particular trajectory associated with a best trajectory identified in a previous computing cycle and currently being executed by the AV is biased at step 550. In some instances, it can be undesirable to oscillate back and forth between different trajectories at each planning cycle. As such, if the AV is currently executing a particular trajectory to merge into a target lane, that trajectory will be biased as a preferred trajectory and will not be overturned, or abandoned in favor of another trajectory, unless there is a very high cost to continuing the trajectory or a very low cost to selecting another trajectory. In some instances, a hysteresis process can be used to determine whether a previously selected and currently executed trajectory can be changed to a new selected trajectory.

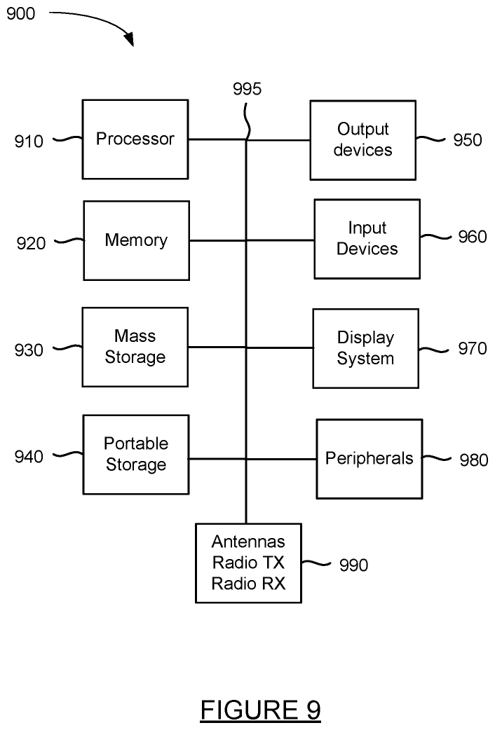

FIG. 9 is a block diagram of a computing environment for implementing a data processing system. System 900 of FIG. 9 may be implemented in the contexts a machine that implements data processing system 125 on an AV. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive, an optical disk drive, a flash drive, or other device, is a non-volatile storage device for storing data and instructions for use by processor unit 910. Mass storage device 930 can store the system software for implementing embodiments of the present technology for purposes of loading that software into main memory 920.

Portable storage device 940 operates in conjunction with a portable non-volatile storage medium, such as a flash drive, USB drive, memory card or stick, or other portable or removable memory, to input and output data and code to and from the computer system 900 of FIG. 9. The system software for implementing embodiments of the present technology may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, a pointing device such as a mouse, a trackball, stylus, cursor direction keys, microphone, touch-screen, accelerometer, wireless device connected via radio frequency, motion sensing device, and other input devices. Additionally, the system 900 as shown in FIG. 9 includes output devices 950. Examples of suitable output devices include speakers, printers, network interfaces, speakers, and monitors.

Display system 970 may include a liquid crystal display (LCD) or other suitable display device. Display system 970 receives textual and graphical information and processes the information for output to the display device. Display system 970 may also receive input as a touch-screen.

Peripherals 980 may include any type of computer support device to add additional functionality to the computer system. For example, peripheral device(s) 980 may include a modem or a router, printer, and other device.

The system of 900 may also include, in some implementations, antennas, radio transmitters and radio receivers 990. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A system for automatically merging a vehicle from a current lane into a target lane, comprising:
a data processing system comprising one or more processors, memory, a planning module, and a control module, the data processing system to:
detect a merge condition associated with a current lane from received sensor data;
select a best trajectory from the current lane to the target lane, the best trajectory selected from a plurality of trajectories at least in part based on a determined cost of a lane change from the current lane, the cost dependent on a change in acceleration in one or more vehicles, the one or more vehicles including the automatically merging vehicle; and
generate one or more commands to navigate a merge from the current lane to the target lane.

2. The system of claim 1, wherein the cost has an opposite value to the difference in acceleration between a target position and the current position of each of the merging vehicle, a lagging vehicle in the target lane, and a lagging vehicle in the current lane.

3. The system of claim 3, wherein the weight of the difference in acceleration for each of the lagging vehicle in the target lane and the lagging vehicle in the current lane is tunable.

4. The system of claim 3, wherein the weights are tuned to increase the significance of the lagging vehicle acceleration change in the cost.

5. The system of claim 3, wherein the weights are tuned to decrease the significance of the lagging vehicle acceleration change in the cost.

6. The system of claim 1, the data processing system further to:
detect the merge condition includes an end to the current lane; and
generate a virtual object at the end of the lane.

7. The system of claim 6, wherein the merging vehicle generates an alert for a user of the merging vehicle when the merging vehicle is within a threshold distance of the virtual object at the end of the lane.

8. The system of claim 1, the data processing system further to:
detect that there is an exit at the end of the current lane; and
navigate the merging vehicle to the exit when the merging vehicle is within a threshold distance of the exit at the end of the lane.

9. The system of claim 1, the data processing system further to:
determine that execution of a decision to navigate a previously selected best trajectory has begun during a previous computing cycle; and
weighting the decision to navigate the previously selected best trajectory.

10. The system of claim 9, wherein a new best trajectory is selected using hysteresis.

11. The system of claim 1, the data processing system further to:
detect a first vehicle object current speed and acceleration in the target lane;
identify a gap adjacent to the first vehicle and forming within a set period of time; and
select the best trajectory at least in part on the identified gap.

12. A non-transitory computer readable storage medium having embodied thereon a program, the program being executable by a processor to perform a method for automatically merging a vehicle from a current lane into a target lane, the method comprising:
detecting a merge condition associated with a current lane from received sensor data;
selecting a best trajectory from the current lane to the target lane, the best trajectory selected from a plurality of trajectories at least in part based on a determined cost of a lane change from the current lane, the cost is dependent on a change in acceleration in one or more vehicles, the one or more vehicles including the automatically merging vehicle; and
generating one or more commands to navigate a merge from the current lane to the target lane.

13. The non-transitory computer readable storage medium of claim 12, wherein the cost is to the opposite value of the difference in acceleration between a target position and the current position of each of the merging vehicle, a lagging vehicle in the target lane, and a lagging vehicle in the current lane.

14. The non-transitory computer readable storage medium of claim 13, wherein the weight of the difference in acceleration for each of the lagging vehicle in the target lane and the lagging vehicle in the current lane is tunable.

15. The non-transitory computer readable storage medium of claim 13, wherein the weights are tuned to increase or decrease the significance of the lagging vehicle acceleration change in the cost.

16. The non-transitory computer readable storage medium of claim 12, the method further including:
detecting the merge condition includes an end to the current lane; and
generating a virtual object at the end of the lane.

17. The non-transitory computer readable storage medium of claim 16, wherein the merging vehicle generates an alert for a user of the merging vehicle when the merging vehicle is within a threshold distance of the virtual object at the end of the lane.

18. The non-transitory computer readable storage medium of claim 12, the method further including:
determining that execution of a decision to navigate a previously selected best trajectory has begun during a previous computing cycle; and
weighting the decision to navigate the previously selected best trajectory.

19. The non-transitory computer readable storage medium of claim 12, the method further including:
detecting a first vehicle object current speed and acceleration in the target lane;
identifying a gap adjacent to the first vehicle and forming within a set period of time; and
selecting the best trajectory at least in part on the identified gap.

20. A method for automatically merging a vehicle from a current lane into a target lane, comprising:
detecting, by a data management system, a merge condition associated with a current lane from received sensor data;
selecting, by a data management system, a best trajectory from the current lane to the target lane, the best trajectory selected from a plurality of trajectories at least in part based on a determined cost of a lane change from the current lane, the cost dependent on a change in acceleration in one or more vehicles, the one or more vehicles including the automatically merging vehicle; and
generating, by a data management system, one or more commands to navigate a merge from the current lane to the target lane.
